(19) United States
(12) Patent Application Publication
(10) Pub. No.: US 2025/0046840 A1
(43) Pub. Date: Feb. 6, 2025

(54) VEHICLE WITH A FUEL CELL SYSTEM AND METHOD FOR OPERATING A FUEL CELL SYSTEM IN A VEHICLE

(71) Applicant: Purem GmbH, Neunkirchen (DE)

(72) Inventor: Gerd Gaiser, Reutlingen (DE)

(21) Appl. No.: 18/793,489

(22) Filed: Aug. 2, 2024

(30) Foreign Application Priority Data
Aug. 2, 2023 (DE) 10 2023 120 480.7

(51) Int. Cl. H01M 8/04701; H01M 8/04007; H01M 8/04746

(52) U.S. Cl. CPC H01M 8/04716; H01M 8/04074; H01M 8/04768; H01M 2250/20

(57) ABSTRACT

A vehicle includes a fuel cell system with a fuel cell arrangement and a fuel cell exhaust gas system receiving fuel cell exhaust gas from the fuel cell arrangement. The fuel cell exhaust gas system has a fuel cell exhaust gas outlet region for discharging fuel cell exhaust gas from the fuel cell exhaust gas system, and an ambient air heating arrangement for heating ambient air to be mixed with at least part of the fuel cell exhaust gas. The ambient air heating arrangement has an ambient air outlet region for discharging ambient air heated in the ambient air heating arrangement. The fuel cell exhaust gas outlet region is positioned downstream of the ambient air outlet region with respect to an ambient air flow direction of the heated ambient air discharged from the ambient air heating arrangement at the ambient air outlet region.

### CROSS-REFERENCE TO RELATED APPLICATIONS

This application claims priority of German patent application no. 10 2023 120 480.7, filed Aug. 2, 2023, the entire content of which is incorporated herein by reference.

### TECHNICAL FIELD

The present disclosure relates to a vehicle with a fuel cell system and to a method for operating a fuel cell system in a vehicle.

### BACKGROUND

In a fuel cell system which is used in a vehicle for generating electrical energy, an anode exhaust gas which is enriched comparatively greatly with water or water vapor or/and a cathode exhaust gas which is enriched comparatively greatly with water or water vapor arise/arises during the conversion of an anode gas which contains hydrogen (H₂) and is fed to an anode region of a fuel cell arrangement and a cathode gas which contains oxygen (O₂) and is fed to a cathode region of the fuel cell arrangement, depending on the type of fuel cell arrangement which is used. If fuel cell exhaust gas, which is enriched greatly in this way with water or water vapor and contains or includes the anode exhaust gas or/and the cathode exhaust gas, is discharged to the environment at a comparatively low ambient temperature, intense fogging may occur upon contact of the water-containing fuel cell exhaust gas with the comparatively cold ambient air at the outlet location of the fuel cell exhaust gas as a result of water condensing out. This is undesirable not only for visual reasons, but also there is the risk of ice being formed as a result of the water condensing out at a low ambient temperature and particularly in the event of a cold underlying surface and precipitating on the underlying surface.

German patent application DE 10 2023 108 806, which is a subsequent publication, discloses a fuel cell exhaust gas system, in which fuel cell exhaust gas containing water or water vapor is mixed in a fuel cell exhaust gas/ambient air mixing arrangement integrated in the fuel cell exhaust gas system with ambient air heated at an ambient air heating arrangement. The fuel cell exhaust gas/ambient air mixing arrangement includes a mixing volume which is formed in a mixing chamber and into which the heated ambient air and the fuel cell exhaust gas are introduced. After mixing of the fuel cell exhaust gas with the ambient air, the mixture of fuel cell exhaust gas and heated ambient air formed in the mixing volume is discharged from the mixing chamber via a part of a fuel cell exhaust gas system lying downstream of the mixing chamber at an outlet opening of the fuel cell exhaust gas system to the environment. In the region of the outlet opening of the fuel cell exhaust gas system, the mixture of fuel cell exhaust gas and heated ambient air is mixed with the unheated ambient air.

### SUMMARY

It is an object of the disclosure to provide a vehicle with a fuel cell system and a method for operating a fuel cell system in a vehicle, with which the risk of fogging when fuel cell exhaust gas is discharged into the environment can be effectively counteracted.

According to a first aspect of the present disclosure, this object is achieved by a vehicle, including:

a fuel cell system with a fuel cell arrangement and a fuel cell exhaust gas system receiving fuel cell exhaust gas from the fuel cell arrangement, wherein the fuel cell exhaust gas system has a fuel cell exhaust gas outlet region for discharging fuel cell exhaust gas from the fuel cell exhaust gas system,

an ambient air heating arrangement for heating ambient air to be mixed with at least part of the fuel cell exhaust gas, wherein the ambient air heating arrangement has an ambient air outlet region for discharging ambient air heated in the ambient air heating arrangement.

In an embodiment according to the disclosure of a vehicle, the fuel cell exhaust gas outlet region is positioned downstream of the ambient air outlet region with respect to an ambient air flow direction of the heated ambient air discharged from the ambient air heating arrangement at the ambient air outlet region. This means that the heated ambient air leaving the ambient air heating arrangement can flow around the fuel cell exhaust gas outlet region and mixing of fuel cell exhaust gas and heated ambient air is thereby brought about or assisted.

In an alternative configuration according to the disclosure of a vehicle, the fuel cell exhaust gas outlet region is positioned upstream of the ambient air outlet region with respect to the ambient air flow direction of the heated ambient air discharged from the ambient air heating arrangement at the ambient air outlet region. In this configuration, it may be provided that the fuel cell exhaust gas discharged at the fuel cell exhaust gas outlet region flows around the ambient air heating arrangement, but is not heated in the ambient air heating arrangement, and is mixed with the ambient air discharged in heated form from the latter.

In a further alternative configuration according to the disclosure, which may also be realized in the case of the previously explained alternative configurations of a vehicle, the fuel cell exhaust gas outlet region and the ambient air outlet region are positioned in such a manner that a flow of fuel cell exhaust gas discharged at the fuel cell exhaust gas outlet region and a flow of heated ambient air discharged at the ambient air outlet region permeate each other at least in some regions. In this configuration, the two gas flows, for example, can be conducted substantially parallel or at an angle to each other in substantially the same volume region, and therefore these gas flows permeate each other and, in the process, the fuel cell exhaust gas is mixed with the heated ambient air.

Owing to the fact that, in the case of a vehicle constructed according to the disclosure, heated ambient air is admixed with the fuel cell exhaust gas, which is greatly enriched with water or water vapor, it is possible to provide this mixture with a relative humidity of significantly below 100% before the fuel cell exhaust gas or the mixture generated from the fuel cell exhaust gas and the heated ambient air is discharged. If this mixture with a significantly reduced relative humidity compared to the fuel cell exhaust gas comes into contact with comparatively cold ambient air when discharged from the fuel cell exhaust gas system, the risk that a spontaneous cooling of the mixture will cause the relative humidity to reach or exceed a value of 100% and thus fogging will occur is significantly reduced. Since, in the case of a vehicle constructed according to the disclosure, the heated ambient air is mixed with the fuel cell exhaust gas discharged from the fuel cell exhaust gas system, system regions which serve for mixing fuel cell exhaust gas and heated ambient air do not need to be integrated in the fuel cell exhaust gas system. The fuel cell exhaust gas system can thus be conventionally constructed, with only the fuel cell exhaust gas outlet region of the system being positioned on the vehicle or in the vehicle in such a manner that the fuel cell exhaust gas escaping from the fuel cell exhaust gas system and the heated ambient air are discharged into the same volume region, for example, in the vehicle or in a region outside the vehicle.

In order to be able to efficiently heat the heated ambient air to be mixed with the fuel cell exhaust gas without additional energy input or without using electrical energy generated in a fuel cell system, it is proposed that the ambient air heating arrangement includes at least one heat exchanger, through which the ambient air to be heated and a cooling medium flowing in a cooling circuit can flow, for transmitting heat contained in the cooling medium to the ambient air to be heated.

For example, if a plurality of cooling circuits are provided in a vehicle, in order to be able to cool different system regions of the vehicle, such as the electronics, on the one hand, and a fuel cell arrangement, on the other hand, independently of one another and to be able to keep them at different temperature levels independently of one another, the ambient air heating arrangement may include a plurality of heat exchangers, through which the ambient air to be heated can flow in series. In this case, for efficient heating of the ambient air, for example, the fuel cell exhaust gas outlet region can be positioned downstream of a heat exchanger, which is positioned furthest downstream, of the plurality of heat exchangers with respect to a flow direction of the ambient air to be heated.

In order to achieve regulation of the temperature of the heated ambient air, the regulation in particular also being adapted to the water content of the fuel cell exhaust gas, the ambient air heating arrangement can be assigned a flow throttle arrangement for restricting the amount of ambient air to be heated that flows through the ambient air heating arrangement.

For discharging the fuel cell exhaust gas into a volume region outside the fuel cell exhaust gas system, the fuel cell exhaust gas outlet region can have at least one fuel cell exhaust gas outlet opening.

The efficient mixing of fuel cell exhaust gas and heated ambient air can be assisted, for example, in that:

at least one, preferably each fuel cell exhaust gas outlet opening is configured for discharging fuel cell exhaust gas in a fuel cell exhaust gas flow direction substantially corresponding to the ambient air flow direction,

or/and

at least one, preferably each fuel cell exhaust gas outlet opening is configured for discharging fuel cell exhaust gas in a fuel cell exhaust gas flow direction substantially opposite to the ambient air flow direction,

or/and

at least one, preferably each fuel cell exhaust gas outlet opening is configured for discharging a fuel cell exhaust gas flow which is expanded in the manner of a fan or in the manner of a cone.

In this context, it should be noted that the ambient air flow direction or the fuel cell exhaust gas flow direction each refer to that flow direction or main flow direction which the ambient air or the fuel cell exhaust gas primarily or on average has at the location of the respective discharge.

To further assist the mixing of heated ambient air and fuel cell exhaust gas, a mixing arrangement with at least one ambient air/fuel cell exhaust gas mixer may be arranged downstream of the fuel cell exhaust gas outlet region with respect to the ambient air flow direction.

In order to be able to achieve mixing of heated ambient air and fuel cell exhaust gas, which leads to reducing the relative humidity, even before the heated ambient air and the fuel cell exhaust gas are discharged to the environment, that is, into unheated ambient air, it is proposed that the ambient air outlet region is provided for discharging heated ambient air into an equipment compartment of the vehicle that is open to the environment via at least one opening region, and that the fuel cell exhaust gas outlet region is provided for discharging fuel cell exhaust gas into the equipment compartment. Such an equipment compartment may be a compartment or a volume region in the vehicle, in which other system regions, such as a drive motor, the ambient air heating arrangement, parts of the vehicle electronics and the like, are also arranged.

In order to be able to ensure a substantially uniform mixing of fuel cell exhaust gas and heated ambient air in the equipment compartment upstream of the outlet to the environment, it is advantageous if a distance of the fuel cell exhaust gas outlet region from the ambient air outlet region is less than 50%, preferably less than 10%, of a distance of the at least one opening region from the ambient air outlet region.

To achieve a sufficient flow through the ambient air heating arrangement with ambient air to be heated, for example, when the vehicle is stationary or moving only slowly or when positioning the ambient air heating arrangement in a region of the vehicle that is not directly subjected to an incident flow even when the vehicle is moving, it is proposed, in an independent aspect of the disclosure, which of course may be combined with the aspects of the disclosure explained above or below, that the ambient air heating arrangement is assigned an ambient air fan for conveying ambient air to be heated or/and heated ambient air. If the ambient air fan is arranged downstream of the ambient air heating arrangement with respect to the ambient air flow direction, for example, upstream of the fuel cell exhaust gas outlet region, the ambient air fan simultaneously generates turbulence in the heated ambient air that contributes to the better mixing with fuel cell exhaust gas.

A particularly efficient mixing of heated ambient air and fuel cell exhaust gas can then be achieved using the conveying effect of the ambient air fan if the ambient air fan is arranged downstream of the fuel cell exhaust gas outlet region with respect to the ambient air flow direction.

The fuel cell exhaust gas system may include a fuel cell exhaust gas treatment arrangement having at least one of the following assemblies:
a liquid separator,
a catalytic converter,
a muffler.

The disclosure further relates to a method for operating a fuel cell system in a vehicle, preferably in a vehicle constructed according to the disclosure, in which method a mixture of ambient air and fuel cell exhaust gas which is discharged at a fuel cell exhaust gas outlet region of a fuel cell exhaust gas system, which is assigned to a fuel cell arrangement of the fuel cell system, is generated, wherein at least part of the ambient air admixed with the fuel cell exhaust gas is heated before mixing with the fuel cell exhaust gas.

To achieve a uniform mixing, the heated ambient air and the fuel cell exhaust gas can be discharged into an equipment compartment of the vehicle that is open to the environment, and therefore the mixture of fuel cell exhaust gas and heated ambient air is substantially formed in the equipment compartment before contact with the unheated ambient air surrounding the vehicle.

The heated ambient air to be mixed with the fuel cell exhaust gas can be heated in at least one heat exchanger by thermal interaction with a cooling medium flowing in a cooling circuit of the vehicle.

In order to adjust a temperature of the ambient air to be heated in the at least one heat exchanger, a mass flow of the ambient air flowing through the at least one heat exchanger or/and a mass flow of the cooling medium flowing through the at least one heat exchanger can be changed.

### BRIEF DESCRIPTION OF DRAWINGS

The invention will now be described with reference to the drawings wherein:

FIG. 1 shows, in a schematic illustration, a vehicle with a fuel cell system;

FIG. 2 shows an alternative configuration of an ambient air heating arrangement; and,

FIG. 3 shows an alternative configuration of the vehicle.

### DETAILED DESCRIPTION

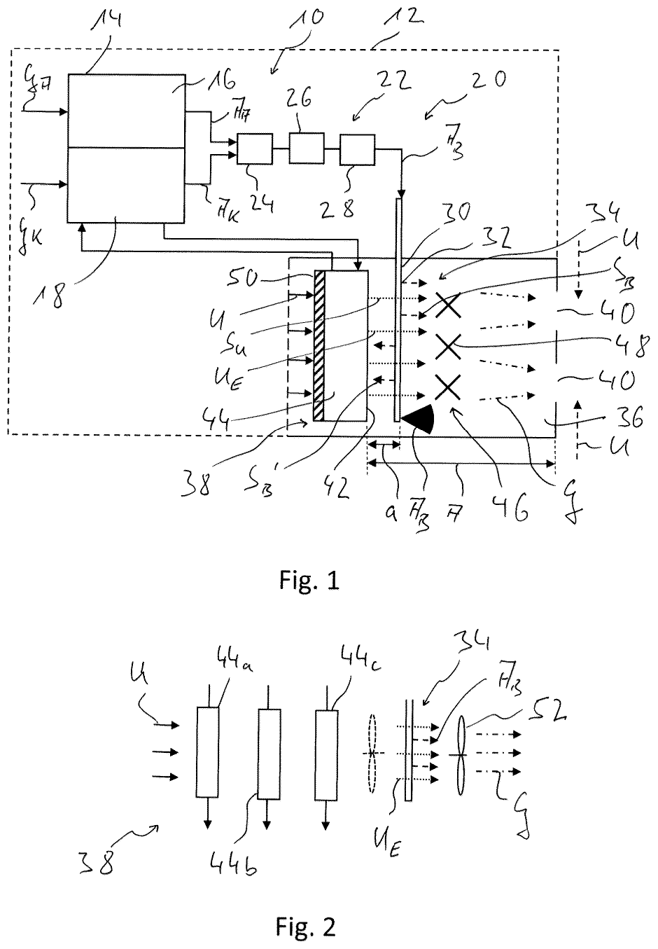

FIG. 1 shows a fuel cell system which is denoted in general by 10 and can be used in a vehicle 12 for the provision of electrical energy. The fuel cell system 10 includes a fuel cell arrangement 14, which can be constructed, for example, with one or more fuel cell stacks and in principle includes an anode region 16 fed with hydrogen-containing anode gas G_{A} and a cathode region 18 fed with oxygen-containing cathode gas G_{K}. In the fuel cell process, by converting the anode gas G_{A} and the cathode gas G_{K}, on the one hand, electrical energy is generated and, on the other hand, an anode exhaust gas A_{A} generally containing residual hydrogen and a cathode exhaust gas A_{K} generally containing residual oxygen are generated. Depending on the type of fuel cell, the anode exhaust gas A_{A} or the cathode exhaust gas A_{K} primarily contains a comparatively high proportion of water or water vapor with a relative humidity in the range of up to 90 to 100%.

The fuel cell arrangement 14 is assigned to a fuel cell exhaust gas system generally denoted by 20. In the example illustrated, the fuel cell exhaust gas system 20 receives the anode exhaust gas A_{A} and the cathode exhaust gas A_{K} as fuel cell exhaust gas A_{B}. Alternatively, the fuel cell exhaust gas system 20 could be constructed in such a way that it receives only the one of the two exhaust gas flows leaving the fuel cell arrangement 14 that is greatly or more greatly enriched with water or water vapor.

In an upstream region of the fuel cell exhaust gas system 20, a fuel cell exhaust gas treatment arrangement 22 may be provided. The fuel cell exhaust gas treatment arrangement 22 may, for example, include a liquid separator 24 in which, for example, larger liquid accumulations or liquid droplets contained in the fuel cell exhaust gas A_{B} can be separated and, for example, fed to the fuel cell process. The fuel cell exhaust gas treatment arrangement 22 may include a catalytic converter 26 for the after-treatment of the fuel cell exhaust gas A_{B} and may, for example, have a muffler 28.

It should be noted that other or additional assemblies of the fuel cell exhaust gas treatment arrangement 22 may be provided or individual assemblies of the three assemblies of the fuel cell exhaust gas treatment arrangement 22 shown may not be present in the fuel cell exhaust gas system 20 or may be positioned in a different sequence.

The fuel cell exhaust gas system 20 furthermore includes a fuel cell exhaust gas outlet region 34 downstream of the fuel cell exhaust gas treatment arrangement 22. In the fuel cell exhaust gas outlet region 34, the fuel cell exhaust gas system 20 has at least one fuel cell exhaust gas outlet opening 32, in the illustrated embodiment a plurality of fuel cell exhaust gas outlet openings 32, via which the fuel cell exhaust gas A_{B} leaves the fuel cell exhaust gas system 20. For example, the fuel cell exhaust gas outlet region 34 may include a tubular end portion 30 of the fuel cell exhaust gas system 20, in which a plurality of the fuel cell exhaust gas outlet openings 32 are arranged sequentially in the longitudinal direction thereof, that is, also in the flow direction, or/and are distributed around the circumference thereof.

In the embodiment illustrated in FIG. 1, the fuel cell exhaust gas outlet region 34 is positioned in such a way that the fuel cell exhaust gas A_{B} is discharged into a volume providing, for example, an equipment compartment 36 in the vehicle 12. Other system regions of the vehicle 12, such as an electric drive motor of the vehicle 12 that is fed from the fuel cell arrangement 14 or from a battery, components of the vehicle electronics or even an ambient air heating arrangement 38, explained below, may be arranged in the equipment compartment 36. The equipment compartment 36 is in principle not a volume encapsulated in the vehicle 12, but rather is generally open to the outside, that is, to the environment, via a plurality of opening regions 40. Access to the equipment compartment 36 can be obtained via a movable end flap, for example an engine hood or the like.

The ambient air heating arrangement 38 is used to receive ambient air U and to discharge it as heated ambient air U_{E} at an ambient air outlet region 42. In an advantageous configuration, the ambient air heating arrangement 38 includes a heat exchanger 44, through which a cooling medium, generally a liquid cooling medium, which circulates in a cooling circuit, which is assigned to, for example, the fuel cell arrangement 14 and absorbs heat therefrom, flows. For example, the heat exchanger 44 can be provided by a vehicle radiator which is present in the vehicle 12 and through which the relative wind can flow. In the heat exchanger 28, the ambient air U received from the outside absorbs heat from the cooling medium and then flows as heated ambient air U_{E} into the equipment compartment 36.

The fuel cell exhaust gas outlet region 34 of the fuel cell exhaust gas system 20 is arranged downstream of the heat exchanger 38 or of the ambient air outlet region 42 with respect to an ambient air flow direction S_{U}. The heated ambient air U_{E} leaving the ambient air heating arrangement 38 thus flows in the ambient air flow direction S_{U} onto the fuel cell exhaust gas outlet region 34 of the fuel cell exhaust gas system 20 or flows into a volume region, into which the fuel cell exhaust gas A_{B} from the fuel cell exhaust gas outlet region 34 is also discharged. In this volume region, that is, in the equipment compartment 36 in the illustrated embodiment, the fuel cell exhaust gas A_{B} and the heated ambient air U_{E} are thus mixed, and therefore a mixture G of fuel cell exhaust gas A_{B} and heated ambient air U_{E} is formed.

FIG. 1 shows different configurations of the fuel cell exhaust gas outlet region 34 and the fuel cell exhaust gas outlet openings 32. In the upper region of the fuel cell exhaust gas outlet region 34, the outlet openings 32 are positioned in such a way that a fuel cell exhaust gas flow direction S_{B} substantially corresponds to the ambient air flow direction S_{U} of the heated ambient air U_{E}. This means that these two flow directions S_{U}, S_{B} or the main flow directions of the two gas flows are substantially parallel to each other and aligned in the same direction. In the central region of the fuel cell exhaust gas outlet region 34, the outlet openings 32 are arranged in such a way that the fuel cell exhaust gas flow direction S_{B′} is substantially opposed to the ambient air flow direction S_{U}, and these two flow directions S_{U}, S_{B′} or the main flow directions of the two gas flows are thus directed substantially parallel to each other and opposed to each other. The lower part of FIG. 1 shows that, at such a fuel cell exhaust gas outlet opening 32, the fuel cell exhaust gas A_{B} is not discharged as an exhaust gas jet substantially aligned in the same direction, but rather in a fan-like or conical configuration. In this case, the main flow direction substantially corresponding to a center line of a discharging fan or discharging cone can also either be directed opposed to the ambient air flow direction S_{U} or, as illustrated, in the same direction as the latter, or can be angled in another manner, for example orthogonally, to the ambient air flow direction S_{U}.

It should be noted that, in the fuel cell exhaust gas outlet region 34, all of the fuel cell exhaust gas outlet openings 32 can have one of the three different configurations described above and illustrated in FIG. 1 or fuel cell exhaust gas outlet openings 32 of a different configuration may be provided. It is also possible to orient the or some of the fuel cell exhaust gas outlet openings 32 in such a way that the heated ambient air U_{E} flowing around the fuel cell exhaust gas outlet region 34 is discharged transversely with respect to the ambient air flow direction S_{U}, in order also thereby to assist the mixing of fuel cell exhaust gas A_{B} and heated ambient air U_{E}. In a configuration of a fuel cell exhaust gas outlet opening 32 for discharging fuel cell exhaust gas A_{B} in a fan-like or conical configuration, the fuel cell exhaust gas outlet region 34 can have, for example, only a single fuel cell exhaust gas outlet opening 32, via which the fuel cell exhaust gas A_{B} is discharged with a main flow direction substantially orthogonal to the ambient air flow direction S_{U}, such that the two gas flows permeate each other.

The mixing of fuel cell exhaust gas A_{B} and heated ambient air U_{E} can furthermore be assisted by a fuel cell exhaust gas/ambient air mixing arrangement 46 provided downstream of the fuel cell exhaust gas outlet region 34. The arrangement can include one or more mixers 48, which can be formed, for example, with deflection vanes providing for turbulence or a flow deflection, and thereby cause an efficient mixing of the fuel cell exhaust gas A_{B} with the heated ambient air U_{E}.

By mixing the fuel cell exhaust gas A_{B} having a high relative humidity with the heated ambient air U_{E} having a comparatively low relative humidity, the fuel cell exhaust gas/ambient air mixture G is provided with a relative humidity which is significantly lower than the relative humidity of the fuel cell exhaust gas A_{B} and has a value of well below 100%. If the fuel cell exhaust gas/ambient air mixture G with its relative humidity lying significantly below a value of 100% exits to the environment from the equipment compartment 36 at the opening regions 40, this occurs spontaneously in contact with the cold ambient air U during operation at a comparatively low ambient temperature. This leads to the temperature also decreasing spontaneously by the mixing of the fuel cell exhaust gas/ambient air mixture G with the comparatively cold ambient air U. Since the relative humidity of the fuel cell exhaust gas/ambient air mixture G before this mixing with the ambient air U lies significantly below 100%, it is possible that, when the temperature of the fuel cell exhaust gas/ambient air mixture G drops upon the mixing with the cold ambient air U, the relative humidity exceeds the value of 100% and thus fogging due to water condensing out virtually does not arise.

In order to be able to adjust the thermal interaction of the unheated ambient air U introduced into the heat exchanger 44 with the cooling medium in a defined manner, the heat exchanger 44 can be assigned a flow throttle arrangement 50. The latter may include, for example, a plurality of lamellae, which are adjustable in order to change the throughflow capability, upstream of the heat exchanger 44. By pivoting of the lamellae and thus changing the throughflow capability of the flow throttle arrangement 42, the amount of ambient air U flowing through the heat exchanger 44 is changed. If less ambient air U is introduced into the heat exchanger 44, the heat transported in the cooling medium is transmitted to a smaller amount of air, which may result in the ambient air U_{E} leaving the heat exchanger 44 in heated form having a higher temperature. Thus, by regulating the amount of air flowing through the heat exchanger 44, on the one hand, and therefore the temperature of the heated ambient air U_{E} leaving the heat exchanger 44, on the other hand, changes in the relative humidity of the fuel cell exhaust gas A_{B} can be reacted to, in order therefore to be able to generate a fuel cell exhaust gas/ambient air mixture G with a minimally possible relative humidity in the equipment compartment 36.

By introducing the fuel cell exhaust gas A_{B} and the heated ambient air U_{E} into the equipment compartment 36, it can be ensured that, even before contact with the unheated or cold ambient air U, there is uniform mixing of heated ambient air U_{E} and fuel cell exhaust gas A_{B}. For this purpose, it is particularly advantageous if a distance a of the fuel cell exhaust gas outlet region 34 or the fuel cell exhaust gas outlet openings 32 from the ambient air outlet region 42 is not greater than 50%, preferably not greater than 10%, of a distance A of the opening regions 40 from the ambient air outlet region 42, at which opening regions 40, for example, in the region of an underbody of the vehicle 12 or in lateral regions or in the rear region of the vehicle, the fuel cell exhaust gas/ambient air mixture G escapes into the environment and comes into contact with the cold ambient air U. For example, the distance a may be the distance at which the fuel cell exhaust gas outlet opening 32 furthest away from the ambient air outlet region 42 is from the ambient air outlet region 42. The distance A may, for example, be the distance at which the opening region 40 closest to the ambient air outlet region 42 is from the ambient air outlet region 42.

In a further embodiment variant of the ambient air heating arrangement 38 that is illustrated in FIG. 2, the arrangement may have a plurality of heat exchangers 44a, 44b, 44c, through which the ambient air U to be heated flows successively, that is, in series. The heat exchangers 44a, 44b, 44c can be assigned to different cooling circuits, which can be provided for cooling different system regions independently of one another in the vehicle 12 or to keep them at defined temperature levels independently of one another. For example, the heat exchanger 44a which is positioned furthest upstream and against which the ambient air U to be heated first strikes can be a low-temperature heat exchanger, while the heat exchanger 44b can be a medium-temperature heat exchanger and the heat exchanger 44c can be a high-temperature heat exchanger, which is provided, for example, to dissipate heat from the fuel cell arrangement 14 or to keep the latter at a defined temperature level. This means that the temperature of the cooling media flowing through the heat exchangers 44a, 44b, 44c increases in the flow direction of the ambient air U to be heated. Downstream of the heat exchanger 44c with the highest cooling medium temperature, the fuel cell exhaust gas outlet region 34 is positioned to discharge the fuel cell exhaust gas A_{B} into the heated ambient air U_{E} that flows around it.

FIG. 2 furthermore illustrates that an ambient air fan 52 can be provided for assisting or generating the flow of the ambient air to be heated or which is heated. Thus, in particular even when the vehicle 12 is stationary, a sufficient flow through the ambient air heating arrangement 38 and thus the provision of a sufficient amount of heated ambient air U_{E} can be ensured. Especially when the ambient air heating arrangement 38 is positioned, for example, on a bus or a train or a locomotive in such a way that it is not directly subjected to the flow of relative wind, the ambient air fan 52 is particularly advantageous for generating a sufficient ambient air flow.

While, in principle, the ambient air fan 52 can also be arranged upstream of the ambient air heating arrangement 38, that is, upstream of the heat exchanger or all of the heat exchangers thereof, the positioning directly downstream of the fuel cell exhaust gas outlet region 34 is particularly advantageous, since then the turbulence, which is generated by the ambient air fan 52, in the heated ambient air U_{E} assists the mixing with the fuel cell exhaust gas A_{B}. This effect can also be achieved if, as indicated in FIG. 2 with a dashed line, the ambient air fan 52 is positioned in the flow direction of the heated ambient air U_{E} downstream of the ambient air heating arrangement 38 and upstream of the fuel cell exhaust gas outlet region 34.

In a further variant of a vehicle constructed according to the disclosure, the fuel cell exhaust gas outlet region 34 and the ambient air outlet region 42 on the vehicle 12 can be positioned in principle in such a way that they do not discharge the fuel cell exhaust gas A_{B} and the heated ambient air U_{E} into a volume region which is formed in the vehicle 12 and is in principle open to the environment, for example, into the equipment compartment 36, but instead discharge the two gas flows, for example directly adjacent to each other, substantially directly into the environment or into the unheated ambient air U, and therefore the two gas flows are essentially mixed only in the environment, that is, outside the vehicle 12. In order to ensure a sufficient reduction in the relative humidity of the fuel cell exhaust gas, it is advantageous if the amount of the discharged heated ambient air U_{E} is significantly greater than the amount of the discharged fuel cell exhaust gas A_{B}. In such a configuration, the discharging of the two gas flows in such a way that, for example, the flow of the fuel cell exhaust gas A_{B} is discharged to the environment surrounded by a jacket flow of heated ambient air U_{E} can also assist in mixing fuel cell exhaust gas A_{B} and heated ambient air U_{E}, leading to a sufficient reduction in the relative humidity.

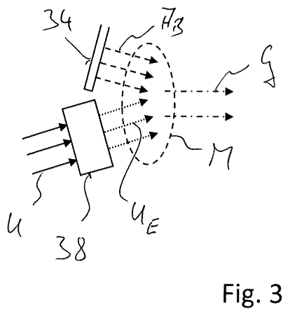

FIG. 3 illustrates such an embodiment in which the ambient air heating arrangement 38 and the fuel cell exhaust gas outlet region 34 are positioned so close to each other or next to each other that the gas flows discharged by them are introduced substantially next to each other into the volume region indicated in FIG. 3 as a mixing zone M. The flows of fuel cell exhaust gas A_{B} and heated ambient air U_{E} permeate each other in the region of the mixing zone M, thus resulting in the fuel cell exhaust gas/ambient air mixture G.

As explained above, such a mixing zone M may be located outside the vehicle 12, but may also be located within the vehicle 12, for example in a region corresponding to the equipment compartment 36 in a volume surrounded by a lateral surface of the vehicle.

While, in such a configuration, the angled positioning, which can be seen in FIG. 3, of the ambient air heating unit 38 and the fuel cell exhaust gas outlet region 34 with respect to each other is particularly advantageous in order to achieve the gas flows permeating each other, it is also possible in principle to arrange the ambient air heating unit 38 and the fuel cell exhaust gas outlet region 34 with respect to each other in such a way that the flow directions S_{B}, S_{U} are substantially parallel to each other. In particular, if in such a configuration, the mixing zone M lies outside the vehicle 12, for example under the underbody of same, the mixing of fuel cell exhaust gas A_{B} and heated ambient air U_{E} can be brought about or assisted by the ambient air which receives the two gas flows and which, when the vehicle 12 is moving, has a relative speed with respect to the two gas flows leading to turbulence.

In a further alternative configuration, the ambient air heating arrangement 38 and the fuel cell exhaust gas outlet region 34 can be arranged with respect to each other in such a way that the fuel cell exhaust gas outlet region 34 is arranged upstream of the ambient air heating arrangement 38 and the ambient air outlet region 42 thereof with respect to the ambient air flow direction S_{U}. The fuel cell exhaust gas A_{B} can be guided in such a way that it flows around the ambient air heating arrangement 38, that is, for example, the heat exchanger 44, but is not heated therein. Downstream of the ambient air outlet region 42, the fuel cell exhaust gas As and the heated ambient air U_{E} exiting at the ambient air outlet region 42 then mix.

It is understood that the foregoing description is that of the preferred embodiments of the invention and that various changes and modifications may be made thereto without departing from the spirit and scope of the invention as defined in the appended claims.

1. A vehicle, comprising: a fuel cell system including:
a fuel cell arrangement;
a fuel cell exhaust gas system receiving fuel cell exhaust gas from said fuel cell arrangement;
a fuel cell exhaust gas outlet region for discharging said fuel cell exhaust gas from said fuel cell exhaust gas system;
an ambient air heating arrangement for heating ambient air for mixing with at least part of said fuel cell exhaust gas;
said ambient air heating arrangement having an ambient air outlet region for discharging ambient air heated in said ambient air heating arrangement;
wherein one of i) or ii) applies:
i) said fuel cell exhaust gas outlet region is disposed downstream of said ambient air outlet region with respect to an ambient air flow direction of said heated ambient air discharged from said ambient air heating arrangement at said ambient air outlet region; or,
ii) wherein at least one of the following applies:
a) said fuel cell exhaust gas outlet region is disposed upstream of said ambient air outlet region with respect to said ambient air flow direction of said heated ambient air discharged from said ambient air heating arrangement at said ambient air outlet region; and,
b) said fuel cell exhaust gas outlet region and said ambient air outlet region are disposed in such a manner that a flow of said fuel cell exhaust gas discharged at said fuel cell exhaust gas outlet region and a flow of the heated ambient air discharged at said the ambient air outlet region permeate each other at least in some regions.

2. The vehicle of claim 1, wherein said ambient air heating arrangement comprises a heat exchanger wherethrough the ambient air to be heated and a cooling medium flowing in a cooling circuit can flow to transmit heat contained in said cooling medium to the ambient air to be heated.

3. The vehicle of claim 2, wherein said ambient air heating arrangement comprises a plurality of said heat exchangers wherethrough the ambient air to be heated flows in series.

4. The vehicle of claim 3, wherein said fuel cell exhaust gas outlet region is positioned downstream of one of said plurality of heat exchangers positioned furthest downstream of said plurality of heat exchangers with respect to a flow direction of the ambient air to be heated.

5. The vehicle of claim 1, wherein said ambient air heating arrangement is assigned a flow throttle arrangement for restricting the amount of ambient air to be heated that flows through said ambient air heating arrangement.

6. The vehicle of claim 1, wherein said fuel cell exhaust gas outlet region has at least one fuel cell exhaust gas outlet opening or a plurality of fuel cell exhaust gas openings.

7. The vehicle of claim 5, wherein at least one of the following applies:
i) said at least one or each of said plurality of fuel cell exhaust gas outlet openings is configured for discharging fuel cell exhaust gas in a fuel cell exhaust gas flow direction corresponding to the ambient air flow direction; and,
ii) said at least one or each of said plurality of fuel cell exhaust gas outlet openings is configured for discharging fuel cell exhaust gas in a fuel cell exhaust gas flow direction substantially opposite to the ambient air flow direction; and,
iii) said at least one or each of said plurality of fuel cell exhaust gas outlet openings is configured for discharging a fuel cell exhaust gas flow which is expanded in the manner of a fan or in the manner of a cone.

8. The vehicle of claim 1, further comprising:
a mixing arrangement having an ambient air/fuel cell exhaust gas mixer; and,
said mixing arrangement being arranged downstream of said fuel cell exhaust gas outlet region with respect to the ambient air flow direction.

9. The vehicle of claim 1, further comprising:
an equipment compartment open to the environment via an opening region;
said ambient air outlet region being provided for discharging heated ambient air into said equipment compartment; and,
said fuel exhaust gas outlet region being provided for discharging fuel cell exhaust gas into said equipment compartment.

10. The vehicle of claim 9, wherein a distance (a) of said fuel cell exhaust gas outlet region from said ambient air outlet region is one of the following: less than 50%, and less than 10%, of a distance (A) of said opening region from said ambient air outlet region.

11. The vehicle of claim 1, wherein:
said ambient air heating arrangement is assigned an ambient air fan conveying ambient air to be heated and/or heated ambient air; and,
said ambient air fan is arranged downstream of said ambient air heating arrangement with respect to the ambient air flow direction.

12. The vehicle of claim 11, wherein said ambient air fan is arranged downstream of said fuel cell exhaust gas outlet region with respect to the ambient air flow direction.

13. The vehicle of claim 1, wherein said fuel cell exhaust gas system further comprises a fuel cell exhaust gas treatment arrangement, wherein the fuel cell exhaust gas treatment arrangement includes at least one of the following: a liquid separator, a catalytic converter and a muffler.

14. A method for operating a fuel cell system in a vehicle having: a fuel cell system including: a fuel cell arrangement; a fuel cell exhaust gas system receiving fuel cell exhaust gas from said fuel cell arrangement; a fuel cell exhaust gas outlet region for discharging said fuel cell exhaust gas from said fuel cell exhaust gas system; an ambient air heating arrangement for heating ambient air for mixing with at least part of said fuel cell exhaust gas; said ambient air heating arrangement having an ambient air outlet region for discharging ambient air heated in said ambient air heating arrangement; wherein one of i) or ii) applies: i) said fuel cell exhaust gas outlet region is disposed downstream of said ambient air outlet region with respect to an ambient air flow direction of said heated ambient air discharged from said ambient air heating arrangement at said ambient air outlet region; or, ii) wherein at least one of the following applies: a) said fuel cell exhaust gas outlet region is disposed upstream of said ambient air outlet region with respect to said ambient air flow direction of said heated ambient air discharged from said ambient air heating arrangement at said ambient air outlet region; and, b) said fuel cell exhaust gas outlet region and said ambient air outlet region are disposed in such a manner that a flow of said fuel cell exhaust gas discharged at said fuel cell exhaust gas outlet region and a flow of the heated ambient air discharged at said the ambient air outlet region permeate each other at least in some regions, the method comprising:
generating a mixture of ambient air and fuel cell exhaust gas discharged at the fuel cell exhaust gas outlet region of the fuel cell exhaust gas system, which is assigned to a fuel cell arrangement of the fuel cell system; and,
heating at least part of the ambient air admixed with the fuel cell exhaust gas before mixing with the fuel cell exhaust gas.

15. The method of claim 14, wherein the heated ambient air and the fuel cell exhaust gas are discharged into an equipment compartment of the vehicle that is open to the environment, and wherein the mixture of fuel cell exhaust gas and heated ambient air is formed in the equipment compartment.

16. The method of claim 14, wherein the heated ambient air to be mixed with the fuel cell exhaust gas is heated in at least one heat exchanger by thermal interaction with a cooling medium flowing in a cooling circuit of the vehicle.

17. The method of claim 16, wherein, in order to adjust a temperature of the ambient air to be heated in the heat exchanger, a mass flow of the ambient air flowing through the heat exchanger and/or a mass flow of the cooling medium flowing through the heat exchanger is changed.
